(19) United States
(12) Patent Application Publication
(10) Pub. No.: US 2025/0296252 A1
(43) Pub. Date: Sep. 25, 2025

(54) In-Space Expandable Robotics Testbed (ISERT)

(71) Applicant: Oceaneering International, Inc., Houston, TX (US)

(72) Inventor: Marc CHRISTENSEN, Friendswood, TX (US)

(73) Assignee: Oceaneering International, Inc., Houston, TX (US)

(21) Appl. No.: 19/084,751

(22) Filed: Mar. 20, 2025

Related U.S. Application Data
(60) Provisional application No. 63/567,579, filed on Mar. 20, 2024.

(51) Int. Cl. B25J 21/00; B25J 9/16; B25J 17/02; B25J 19/00; G01D 11/24

(52) U.S. Cl. CPC B25J 21/005; B25J 9/1697; B25J 17/0283; B25J 19/0075; G01D 11/24

(57) ABSTRACT

An in-space expandable robotics testbed comprises a multi-sided expandable and contractable enclosure which can contain a predetermined set of objects within, a robotic arm disposed within the expandable and contractable enclosure and robotic arm controller configured to command the robotic arm to perform a desired function from a predetermined set of functions within the expandable and contractable enclosure, and a controllable expander operatively in communication with the expandable and contractable enclosure and operable to expand and contract the expandable and contractable enclosure. The in-space expandable robotics testbed may be used to perform a predetermined set of functions in a safe environment to test and operate devices in space and perform and allow payload operations for enhanced in-space utilization.

### CROSS-REFERENCE TO RELATED APPLICATIONS

This application claims priority through U.S. Provisional Application 63/567,579 filed on Mar. 20, 2024.

### BACKGROUND OF THE INVENTION

During in-space experimentations, testing, and/or operations, hazardous debris can be released. Initial in-space testing of in-space servicing, assembly, and manufacturing (“ISAM”), free flyers, and other technologies have a high risk of debris generation that cannot be effectively mitigated. ISAM requires significant design optimization and ground testing to mitigate debris generation risk. Classified in-space equipment and operations are externally observable. Extensive secondary development efforts are required for test setups, inspections, and contingency tests. The volume for enclosed in-space tests and operations is limited by launch volume.

### BRIEF DESCRIPTION OF DRAWINGS

Various figures are included herein which illustrate aspects of embodiments of the disclosed inventions.

FIG. 1 is a view in partial perspective of an exemplary in-space expandable robotics testbed and object hub;

FIG. 1A are views in partial perspective of various exemplary configurations of in-space expandable robotics testbeds;

FIG. 1B are views in partial perspective of various exemplary configurations of in-space expandable robotics testbeds illustrating different materials for sides;

FIG. 1C are views in partial perspective of an exemplary extendable boom;

FIG. 2 is a view in partial perspective of an exemplary configuration of in-space expandable robotics testbeds illustrating a robotic arm and object hub;

FIG. 2A are views in partial perspective of an exemplary robotic arm and puck;

FIGS. 3A and 3B are views in partial perspective of an exemplary object hub and payload;

FIG. 4 is a view in partial perspective illustrating an exemplary sensor;

FIG. 5 is a view in partial perspective illustrating an exemplary side with a port;

FIG. 6 are exemplary partial perspective views illustrating deployment of an exemplary in-space expandable robotics testbed including launch and mounting to an in-space platform;

FIG. 7 are exemplary partial perspective views illustrating expansion and contraction of an exemplary in-space expandable robotics testbed;

FIG. 8 is a set of side views illustrating attachment of two payloads for testing and, separately, free-flyer payload travel within an expandable and contractable enclosure; and

FIG. 9 is a set of views in partial perspective illustrating expansion and contraction of an exemplary in-space expandable robotics testbed using a spring and motor.

### DETAILED DESCRIPTION OF EMBODIMENTS OF THE INVENTION

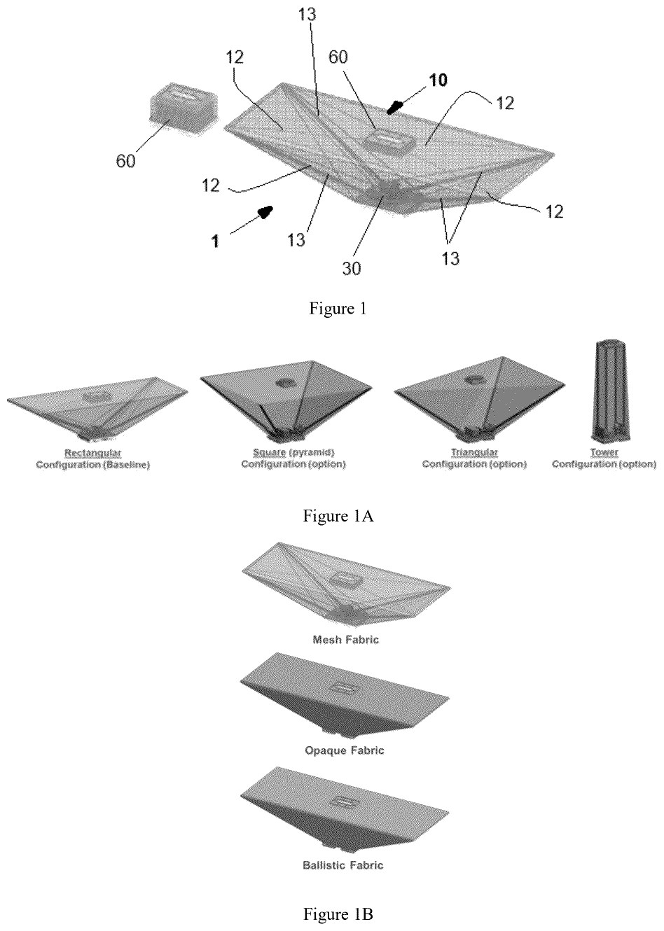

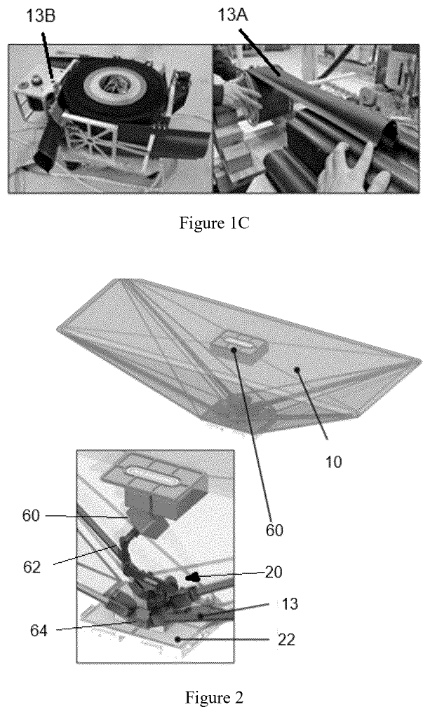

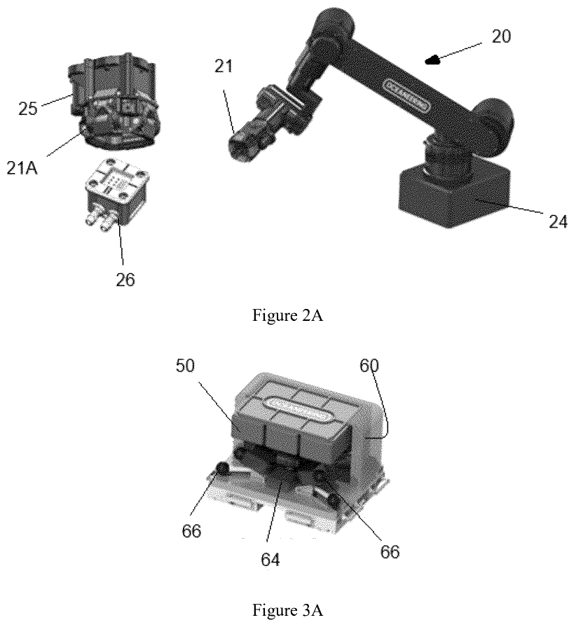

In a first embodiment, referring generally to FIG. 1, in-space expandable robotics testbed 1 comprises expandable and contractable enclosure 10 configured to contain a predetermined set of objects within expandable and contractable enclosure 10, expandable and contractable enclosure 10 comprising a predetermined geometric shape comprising a plurality of sides 12 defining an interior volume when expanded; robotic arm 20 (FIG. 2) disposed within expandable and contractable enclosure 10, robotic arm 20 comprising end effector 21 (FIG. 2A); robotic arm controller 24 (FIG. 2A) configured to command robotic arm 20 to perform a desired function from a predetermined set of functions within expandable and contractable enclosure 10; and controllable expander 30 operatively in communication with expandable and contractable enclosure 10 and operable to expand expandable and contractable enclosure 10 to a volume greater than a work space required by robotic arm 20 and to contract expandable and contractable enclosure 10 to a compacted volume.

Referring additionally to FIG. 1A, expandable and contractable enclosure 10 may comprise a substantially rectangular shape which may be suitable for launching in-space expandable robotics testbed 1. In embodiments, the predetermined geometric shape may comprise a square, a triangle, a rectangle, a rectangular tower, or the like. In embodiments, the interior volume is around 0.14 cubic meter (4.9 cubic feet) of initial payload launch volume.

Expandable and contractable enclosure 10 may be adapted to expand to over nineteen times of its launch volume. Expandable and contractable enclosure 10 may be further configured to controllably prevent the predetermined set of objects from released into space.

Referring additionally to FIG. 1B, a predetermined set of the plurality of sides 12 typically comprises a fabric which may comprise an opaque fabric, a ballistic fabric, a mesh fabric, an electromagnetic interference fabric, a reflective fabric, or the like, or a combination thereof.

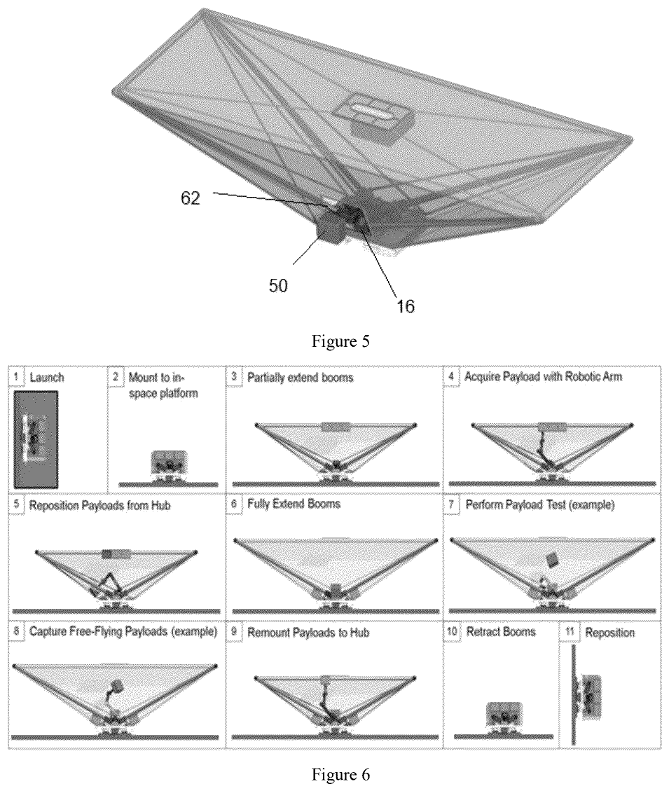

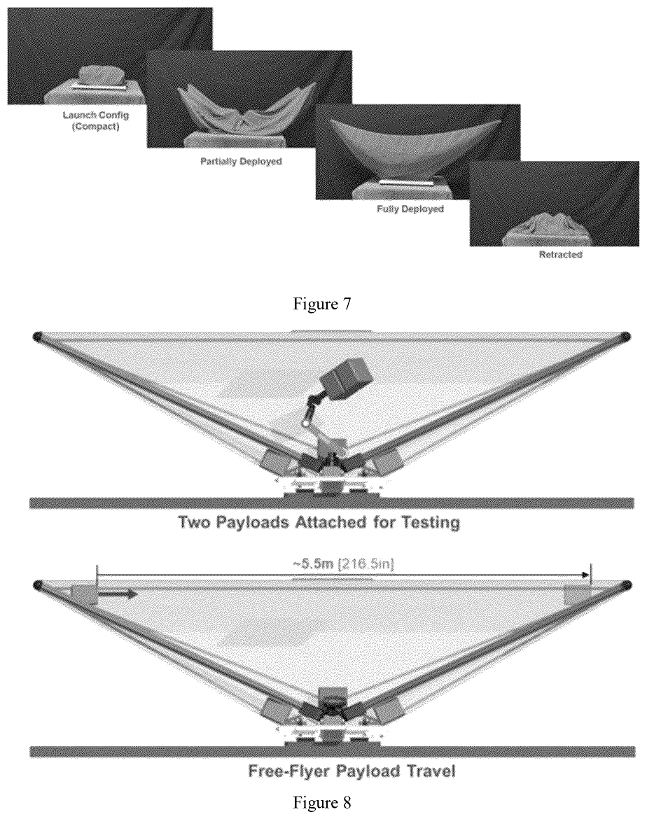

In embodiments, referring additionally to FIG. 5, a predetermined side 12 of the plurality of sides 12 comprises selectively sealable port 16 sized to accommodate passage of payload 50 through port 16. In these embodiments, robotic arm controller 22 (FIG. 2) is typically configured to command robotic arm 20 to maneuver through selectively sealable port 16.

In most embodiments, referring back to FIG. 1, a predetermined set of extendable supports 13 are operatively connected to the plurality of sides 12 and deployable within expandable and contractable enclosure 10. The predetermined set of extendable supports 13 may comprise a set of extendable composite, lightweight structural booms (shown generally in FIG. 6) that can be stowed with minimal area and which are connected to mounts 13B (FIG. 1C) on extension arms 13A (FIG. 1C).

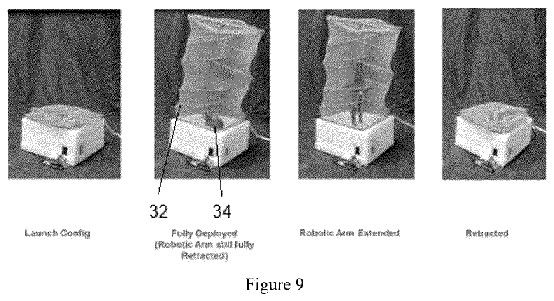

In embodiments, controllable expander 30 may comprise coiled spring 32 (FIG. 9) configured to expand expandable and contractable enclosure 10 and motor 34 (FIG. 9) operatively connected to coiled spring 32 and configured to contract expandable and contractable enclosure 10 by retracting spring 32.

Expandable and contractable enclosure 10 may further comprise a predetermined set of launch restraints 15 (shown generally in FIG. 6) adapted to be secured to limit component movement of in-space expandable robotics testbed 1 into space during a rocket launch.

A predetermined set of sensors 40 (FIG. 4) may be present, and comprise sensors that are operatively in communication with robotic arm 20 controller. In these embodiments, robotic arm 20 controller may be further configured to effect movement of robotic arm 20 using input obtained from predetermined set of sensors 40. In embodiments, where predetermined set of sensors 40 comprise a position sensor and a vision sensor.

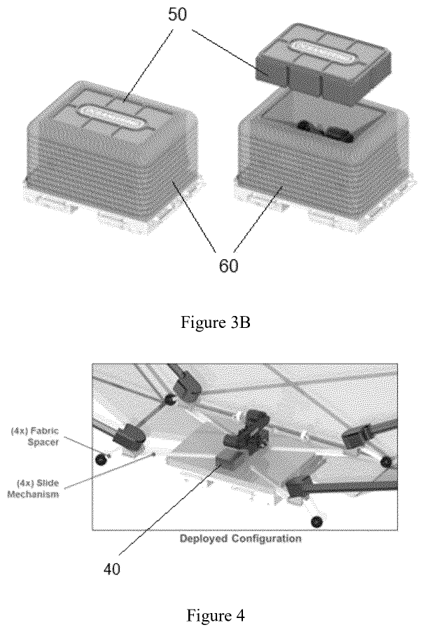

In various embodiments, referring additionally to FIG. 2, object hub 60 (FIG. 3B) may be disposed at least partially within expandable and contractable enclosure 10 and configured to selectively receive or discharge an object of the predetermined set of objects, e.g., payload 50 (FIG. 3A). If object hub 60 is present, object transporter 62 is typically present as well and configured to transport the object of the predetermined set of objects out of expandable and contractable enclosure 10 or into expandable and contractable enclosure 10 such as through selectively sealable port 16. Object transporter controller 64 is typically operatively in communication with object transporter 62. Additionally, a predetermined set of sensors 66 (FIG. 3A) may be present and operatively in communication with the object transporter controller.

Referring generally to FIGS. 2 and 2A, robotic arm 20 typically comprises a 6-Degree of Freedom (DoF) robotic arm configured to operate and manipulate payload 50, capture a loose object, position payload 50, position an object, provide close inspection with integrated cameras, apply a force to a payload component, supply power and communicate to payloads, amnd the like, or a combination thereof. In certain embodiments, robotic arm 20 comprises a reach of ˜1.1 m, with a force-torque sensor 40 mounted within a space latch which comprises an electrical connector for interfacing directly with payload 50 or supplemental end effectors, e.g., 21. Typically, robotic arm 20 has no exposed external wire.

In embodiments, referring additionally to FIG. 2A, in-space expandable robotics testbed 1 further comprises one or more hot melt tech attachments 25 operatively connectable to robotic arm 20 which may accept one or more assemblies. These assemblies may comprise an additive assembly manufacturer operatively connectable to robotic arm 20; large 3D printed structures and assemblies that can extend outside ISERT; a subtractive assembly manufacturer operatively connectable to robotic arm 20; a debris containment attachment; a post build test assembler operatively connectable to robotic arm 20, e.g., loads, deflections, impacts, cycle life, and containing destructive evaluations; a welder assembly operatively connectable to robotic arm 20, e.g., for splatter containment; or the like; or a combination thereof. Common puck 26 may be present and may further be integrated with payload 50 of the predetermined set of objects. If present, a predetermined set of supplemental end effectors 21A may be configured to interface with common puck 26.

In the operation of exemplary methods, referring back to FIG. 1, in-space expandable robotics testbed 1, which is as described above, may be used to provide a safe environment to test and operate devices in space and perform and allow payload operations for enhanced in-space utilization, including initial in-space testing of ISAM, free flyers, and other technologies where debris, “free flyers,” and other technologies are effectively contained using in-space expandable robotics testbed 1 as described herein, by disposing an object, e.g., payload 50, within expandable and contractable enclosure 10; contracting expandable and contractable enclosure 10 to an initial, contracted geometry, such as to prepare for a launch of in-space expandable robotics testbed 1 into space using an appropriate launch vehicle; and, at a predetermined time, commanding expandable and contractable enclosure 10 to expand into an expanded geometry comprising the predetermined geometric shape.

Once expanded to the expanded geometry, robotic arm 20 may be commanded to perform a desired function selected from a predetermined set of functions performable with respect to the predetermined set of objects such as a function that comprises a secure in-space operation. In embodiments, the predetermined set of functions comprise one or more of an intrinsically safe and secure in-space setup, an inspection, and a contingent operation. The predetermined set of functions may also comprise, either with the intrinsically safe and secure in-space functions or in place of those, one or more of a robotic assist setup function; a secondary and contingency payload operation function; a hidden operation and physical shield operation function; an electromagnetic interference (EMI) and radio frequency (RF) shield operation function; a debris mitigation operation function (including from manufacturing and assembly); a size, velocity, and trajectory operation function; a capture and containment operation function; a free flyer testing and pre-deployment operation function; or the like; or a combination thereof.

If present, the free flyer testing and pre-deployment operation function may comprise one or more of a load and impact test; a deployment system; a coordination of multiple free flyers; a dry runs, checkouts, and contingencies (before final deployment); an autonomous operation; a guidance, navigation, and control (GNC) including operator training; a communication (shielded by the enclosure), or the like, or a combination thereof. In embodiments, the desired free flyers testing and pre-deployment may also comprise one or more of loads and impact tests; deployment systems; coordination of multiple free flyers; dry runs, checkouts, and contingencies (before final deployment); autonomous operations; guidance, navigation, and control (GNC) including operator training; or communication (shielded by the enclosure); or the like; or a combination thereof.

By way of example and not limitation, the desired function may comprise one or more of manufacturing and assembly; enclosed operations; debris mitigation (including from manufacturing and assembly); free flyers testing and pre-deployment, or the like, or a combination thereof.

In embodiments, the desired manufacturing and assembly function may comprise one or more of adhesives functions (such as using hot melt technology attachments); additive manufacturing and assembly (such as large 3D printed structures and assemblies which can extend outside in-space expandable robotics testbed 1); subtractive manufacturing (e.g., debris containment); post build tests (e.g., loads, deflections, impacts, cycle life, and containing destructive evaluations); welding (e.g., splatter containment); or the like; or a combination thereof.

In embodiments, the desired enclosed operations may comprise one or more of robotic assist setups; secondary and contingency payload operations; hidden operations and physical shield; an EMI and RF shield; or the like; or a combination thereof.

In embodiments, the desired debris mitigation comprises one or more of size, velocities, and trajectories or capture and containment.

In embodiments, launch restraint 15 may be used to secure in-space expandable robotics testbed 1 to limit movement of objects disposed within expandable and contractable enclosure 10 during rocket launch into space. In addition, in-space expandable robotics testbed 1 may be mounted to an in-space platform, either before or after launch.

Performing the desired function may comprise using robotic arm 20 to acquire payload 50, which may be a free-flying payload; repositioning the acquired payload 50 such as from hub 60; performing a payload test within expandable and contractable enclosure 10; repositioning the acquired payload 50 within expandable and contractable enclosure 10; and retracting extendable supports 13.

In embodiments where expandable and contractable enclosure 10 comprises port 16, the desired function may comprise using robotic arm 20 to pass payload 50 through port 16.

The foregoing disclosure and description of the inventions are illustrative and explanatory. Various changes in the size, shape, and materials, as well as in the details of the illustrative construction and/or an illustrative method may be made without departing from the spirit of the invention.

What is claimed is:

1. An in-space expandable robotics testbed, comprising:
a) an expandable and contractable enclosure configured to contain a predetermined set of objects within the expandable and contractable enclosure, the expandable and contractable enclosure comprising a predetermined geometric shape which comprises a plurality of sides defining an interior volume when expanded;
b) a robotic arm disposed within the expandable and contractable enclosure, the robotic arm comprising an end effector;
c) a robotic arm controller configured to command the robotic arm to perform a predetermined set of functions within the expandable and contractable enclosure; and
d) a controllable expander operatively in communication with the expandable and contractable enclosure and operable to expand the expandable and contractable enclosure to a volume greater than a work space required by the robotic arm and to contract the expandable and contractable enclosure to a compacted volume.

2. The in-space expandable robotics testbed of claim 1, wherein the interior volume is around 0.14 cubic meter (4.9 cubic feet) of an initial payload launch volume.

3. The in-space expandable robotics testbed of claim 1, wherein the expandable and contractable enclosure is further configured to controllably prevent the predetermined set of objects from being released into space.

4. The in-space expandable robotics testbed of claim 1, wherein the predetermined set of functions are performable with respect to the predetermined set of objects.

5. The in-space expandable robotics testbed of claim 1, wherein the predetermined set of functions comprise an intrinsically safe and secure in-space setup function, an inspection function, and a contingent operation function.

6. The in-space expandable robotics testbed of claim 1, further comprising a predetermined set of sensors.

7. The in-space expandable robotics testbed of claim 6, wherein:
a) the predetermined set of sensors are operatively in communication with the robotic arm controller; and
b) the robotic arm controller is configured to effect movement of the robotic arm using input obtained from the predetermined set of sensors.

8. The in-space expandable robotics testbed of claim 6, where the predetermined set of sensors comprise a position sensor and a vision sensor.

9. The in-space expandable robotics testbed of claim 1, wherein a predetermined set of the plurality of sides comprises a fabric.

10. The in-space expandable robotics testbed of claim 9, wherein the fabric comprises an opaque fabric, a ballistic fabric, a mesh fabric, an electromagnetic interference fabric, or a reflective fabric.

11. The in-space expandable robotics testbed of claim 1, wherein:
a) a predetermined side of the plurality of sides comprises a selectively sealable port sized to accommodate passage of a payload through the port; and
b) the robotic arm controller is configured to command the robotic arm to maneuver through the selectively sealable port.

12. The in-space expandable robotics testbed of claim 11, further comprising:
a) an object hub disposed at least partially within the expandable and contractable enclosure and configured to selectively receive or discharge an object of the predetermined set of objects;
b) an object transporter configured to transport the object of the predetermined set of objects out of the expandable and contractable enclosure or into the expandable and contractable enclosure through the selectively sealable port;
c) an object transporter controller operatively in communication with the object transporter; and
d) a predetermined set of sensors operatively in communication with the object transporter controller.

13. The in-space expandable robotics testbed of claim 1, wherein the controllable expander comprises:
a) a coiled spring configured to expand the expandable and contractable enclosure; and
b) a motor operatively connected to the coiled spring and configured to contract the expandable and contractable enclosure by retracting the spring.

14. The in-space expandable robotics testbed of claim 1, wherein the expandable and contractable enclosure comprises a substantially rectangular shape for launch.

15. The in-space expandable robotics testbed of claim 1, further comprising:
a) a hot melt technology attachment operatively connectable to the robotic arm;
b) an additive assembly manufacturer operatively connectable to the robotic arm;
c) a subtractive assembly manufacturer operatively connectable to the robotic arm;
d) a post build test assembler operatively connectable to the robotic arm; and
e) a welder operatively connectable to the robotic arm.

16. The in-space expandable robotics testbed of claim 1, wherein the robotic arm comprises a 6-Degree of Freedom (DoF) robotic arm configured to operate and manipulate a payload, capture a loose object, position a payload, position an object, provide close inspection with integrated cameras, apply a force to a payload component, and supply power and communicate to payloads.

17. The in-space expandable robotics testbed of claim 16, wherein the 6 Degree-of-Freedom (DOF) robotic arm comprises a reach of around 1.1 m and further comprises a force-torque sensor mounted within a space latch which comprises an electrical connector for interfacing directly with the payload or with a supplemental end effector.

18. The in-space expandable robotics testbed of claim 1, further comprising:
a) a common puck integrated with a payload object of the predetermined set of objects; and
b) a predetermined set of supplemental end effectors configured to interface with the common puck.

19. The in-space expandable robotics testbed of claim 1, wherein the predetermined geometric shape comprises a square, a triangle, a rectangle, or a rectangular tower.
